(19) United States
(12) Patent Application Publication
(10) Pub. No.: US 2026/0005877 A1
(43) Pub. Date: Jan. 1, 2026

(54) SYSTEM AND METHOD TO PROVIDE A CRYPTOGRAPHICALLY VERIFIABLE LOGGER

(71) Applicant: Savvas Kerdemelidis, Christchurch (NZ)

(72) Inventor: Savvas Kerdemelidis, Christchurch (NZ)

(21) Appl. No.: 18/755,694

(22) Filed: Jun. 27, 2024

(51) Int. Cl. H04L 9/00; H04L 9/30; H04L 9/32

(52) U.S. Cl. CPC H04L 9/50; H04L 9/3073; H04L 9/3263

(57) ABSTRACT

A system and method is provided for a unique logger associated with a unique cryptographic private and public key pair and certificate to record a log which can be uploaded and verified on an immutable blockchain by an agent holding the other cryptographic private key and the public key recorded on the blockchain. Preferably, the logger is configured to automatically record and encrypt a log with its unique public cryptographic key in response to detection of certain pre-determined conditions configured by an agent, and store such log in non-volatile memory together with time stamps. The logger is also configured by an agent to upload the encrypted log to an immutable blockchain after a certain time period or in response to detection of certain pre-determined conditions. The agent holding the private cryptographic key can decrypt the immutable log on the blockchain to cryptographically verify the authenticity of the log.

### FIELD OF THE INVENTION

The present invention relates generally to a system and method for a database shared by all computing nodes participating in a system based on a blockchain protocol, and a logger to create a cryptographically verifiable log on the blockchain.

Particularly, but not exclusively, the invention relates to a system and method for providing a logger associated with a private and public cryptographic key that is configured to securely record a log which is encrypted by said public key and further including means for securely uploading said encrypted log to an immutable blockchain or distributed ledger, whereby the authenticity and immutability of such log can be verified and decrypted with said private cryptographic key.

### BACKGROUND OF THE INVENTION

Distributed ledger technologies such as blockchains are a means for ensuring that a record is “immutable” and that multiple parties can rely on the fact that the contents are accurate and have not been changed, without the need to involve a ‘trusted’ intermediary.

Solving a computationally difficult cryptographic hashing problem (a proof-of-work process) at a set difficulty initially rewards an entity that solves the problem by awarding an amount of tokens or digital ‘coins’ for the effort. This process is called ‘mining’, and is performed by miners on the network who create the new tokens that they can spend through this work. In addition to creating tokens though mining, miners are also used to ‘confirm’ transactions on the network. Confirmations involve a multitude of ‘peers’ seeing the transaction, and that transaction being added and maintained on what is called the ‘blockchain’. Through this proof-of-work process, the blockchain maintains a record of all valid transactions that have ever been performed. It is also possible to use another more environmentally-friendly ‘mining’ process (proof-of-stake) where it is not necessary to solve a cryptographic hashing problem, but randomly allocating the right to update the record to ‘validator nodes’ that have staked a specific amount of tokens for the right to receive a reward by validating the authenticity of the ledger. This protocol enforces criteria such that a consensus is reached between all peers on the network as to what blocks (containing valid transactions) will be added onto the blockchain, therefore creating an immutable record of transactions.

In addition to the information about what value was transacted in a particular transaction published to the blockchain, it is possible in some blockchains, for example on the Bitcoin network, to incorporate a limited amount of arbitrary data that is separate from transaction data. On Bitcoin, this arbitrary data storage parameter is called the OP_RETURN. It is possible to store, for example, a SHA256 hash, within the OP_RETURN. Since a transaction is published and incorporated into the blockchain at a particular time, as within the series of block headers an immutable time-series is resolved, it is possible to know after what approximate time this transaction existed. If we are to incorporate a cryptographic hash of a specific document, including but not limited to hash algorithms such as SHA256, SHA512, RIPEMD160 into the OP_RETURN, it is understood by those skilled in the art that it provides for proof that a document existed at the time the block was created and syndicated as a canonical block to the blockchain network.

Logger technology is used to monitor and record activity on a particular computer or device or environment when sensors such as keyboard, trackpad or mouse, microphone or video and screen recording are used, which includes software and hardware loggers. However, there is a risk of perception that a recorded log may be tampered with either during or after its recording or is inaccurate which makes the log less reliable. There is a need to ensure that a log as well as associated time-stamp data is tamper proof and authentic, in order to improve confidence and reliance on the contents of the log. This is particularly where it is extremely important to ensure confidence in the accuracy of the log, such as when the contents and associated timestamp may have serious legal consequences. This is also important where it is becoming easier to generate seemingly incriminating but ‘deepfaked’ evidence with artificial intelligence, including video and speech, which would lead to a loss of trust in the authenticity of whistleblower leaks.

Accordingly, it is an object of the present invention to provide a means for overcoming the above-mentioned problems, or at least providing the public with a useful choice. Further objects and advantages of the present invention will be disclosed and become apparent from the following description.

### SUMMARY OF THE INVENTION

A system and method is described herein for providing a system for creating a cryptographically secure record on a database shared by all computing nodes participating in a system based on a blockchain protocol comprising:
providing a unique logger associated with a unique cryptographic private and public key pair which is available to be downloaded from a blockchain by an agent that is provided sole access to the private key;
wherein upon installation of the logger on a target device by an agent, the logger is configured to:
create an encrypted log by recording inputs from the target device's environment with timestamps including keystrokes, screenshots, video, or sound with its unique public key;
store said log in a memory;
upload said log to the blockchain;
wherein the private key can decrypt the log on the blockchain to verify its authenticity and immutability.

Preferably, the logger is configured so that an agent;
downloads the logger and its unique private key from the blockchain;
installs the logger onto a target device; and
decrypts the log uploaded to the blockchain by the logger using their unique private key.

Preferably, the logger is configured to automatically record and encrypt a log with its unique public key at a pre-determined time or event occurring; Preferably, the pre-determined time or event to record the log and upload the log to the blockchain can be pre-configured by the agent.

Preferably, the pre-determined event to record the log and upload the log to the blockchain at a pre-determined time includes detection of specific keystrokes, screenshots, video, or sound.

Preferably, the agent sends a certificate signing request to the blockchain via a blockchain API to register the unique instance of logger creation with timestamp and the blockchain API provides agent signed certificate unique to logger, which is used to sign log prior to encryption of the log by the public key.

According to another aspect of the invention, there is provided a computer-based method for generating a logger comprising the steps of:
Accessing, by a processor, a database shared by all computing nodes participating in a system based on a blockchain protocol, the database including transactions and blocks, where the transactions are data to be stored in a blockchain and the blocks are records that confirm when and in what sequence certain transaction became journaled as part of the blockchain;
Wherein said database also includes a data storage parameter containing a logger which is configured to be associated with a unique cryptographic private and public key pair, that can record a log that can be verified by said blockchain using the private key held by an agent that can download the logger to a separate agent device or computer, and once the logger is installed on a target device or computer by an agent, it is configured to automatically record and encrypt a log with its unique public cryptographic key, at a pre-determined time or event configured by an agent, and store it in non-volatile memory together with time stamps and further wherein the logger is also configured by an agent to upload the encrypted log to an immutable blockchain at a predetermined time or event, and the agent holding the private cryptographic key can then decrypt the immutable log on the blockchain to verify the authenticity of the log.

More specific features for preferred embodiments are set out in the description below.

### BRIEF DESCRIPTION OF THE DRAWINGS

The summary above, as well as the following detailed description of illustrative embodiments, is better understood when read in conjunction with the appended drawings.

For illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

The invention will now be described by way of example only with reference to the accompanying drawings, in which:

FIG. 1 illustrates a simplified block diagram of the cryptographically verifiable logger system comprising an agent device, a target device and a blockchain according to an embodiment of the invention.

FIG. 2 illustrates a flow chart of a method for a software logger to record a cryptographically verifiable log on a target device which is immutably recorded on a blockchain according to an embodiment of the invention.

FIG. 3 illustrates a flow chart of a method for a hardware logger to record a cryptographically verifiable log on a target device which is immutably recorded on a blockchain according to an alternative embodiment of the invention.

FIG. 4 illustrates an expanded block diagram of the cryptographically verifiable software logger system comprising an agent device, a target device and a blockchain according to an embodiment of the invention.

FIG. 5 illustrates an expanded block diagram of the cryptographically verifiable hardware logger system comprising an agent device, a target device and a blockchain according to an embodiment of the invention.

### DETAILED DESCRIPTION OF THE INVENTION

Various embodiments of the present invention are described hereinafter with reference to the figures. It should be noted that the figures are only intended to facilitate the description of specific embodiments of the invention. In addition, an aspect described in conjunction with a particular embodiment of the present invention is not necessarily limited to that embodiment and can be practiced in any other embodiments of the present invention.

The present invention relates generally to a system and method for a database shared by all computing nodes participating in a system based on a blockchain protocol, and a logger to create a cryptographically verifiable log on the blockchain.

Particularly, but not exclusively, the invention relates to a system and method for providing a logger associated with a private and public cryptographic key that is configured to securely record a log which is encrypted by said public key and further including means for securely uploading said log to an immutable blockchain or distributed ledger, whereby the authenticity and immutability of such log can be verified and decrypted with said private cryptographic key.

In an embodiment of this invention, an agent will interact with a blockchain which has software and/or firmware component, preferably open source, stored on it in an immutable and auditable manner, such software or firmware encoding the means for generating a unique private and public cryptographic key which is cryptographically-linked to a unique instance of a software or hardware logger, automatically generated by said software, or automatically updating the firmware for the hardware logger. For an example of a hardware logger that can be improved according to this embodiment of the invention, please refer to U.S. Pat. No. 7,739,431 entitled “Keystroke Monitoring Apparatus and Method”, incorporated by reference. An agent can also interact with the blockchain via an API which allows it to configure and download that instance of the unique logger, which will have the functionality of recording a log from the environment of a target device that it has been installed on, including keystrokes, trackpad or mouse, screen recording, video or microphone, including upon detection of a certain pre-determined event, such as particular trigger word being typed onto the screen or certain person appearing on the video or heard on the microphone. The logger which has been uniquely configured via API to have such pre-determined functionality will also be registered with the blockchain via API with timestamp and provided with a unique certificate to sign the log, which is linked to the unique instance of the logger. A hardware logger may also have an embedded private key, which is used to automatically sign the log to verify it has been recorded by that logger. A person skilled in the art will also recognize that the logger will also have IT security countermeasures to ensure it can be installed on a target device in a manner that can minimize its chance of detection (including, but not limited to controlling the rootkit or OS kernel to hide processes, or connecting passively to a data line) and to also record and encrypt its log, and then upload it back to the blockchain in a secure manner with end-to-end encryption so that any man-in-the-middle attack is not possible. The agent will then be able to de-crypt the log using its private key, thus providing confidence that the logger itself was at least the one which was installed by the agent and not by a third party, assuming that installation was not detected. If the logger installation was detected, then the contents of the log would not be useful anyway, if the purpose of installing the logger would have been to detect illicit activity in the context of law enforcement or investigative journalism. A person skilled in the art will also recognize that a logger can have other uses, including for monitoring and backup purposes.

In various embodiments, this blockchain-enhanced system for cryptographically verifying a log could be furnished through the execution of computer program instructions by computers and/or processors. A computer refers to any programmable entity capable of carrying out arithmetic and/or logical operations. These computers, in certain instances, may encompass processors, memories, data storage devices, and/or other conventional or innovative components. These components may be interconnected physically or via network or wireless connections. Moreover, computers may incorporate software to govern the functionalities of the aforementioned components. They may be denoted by terms commonly employed in relevant fields, such as PCs, mobile devices, servers, routers, switches, distributed computers, data centers and other implementations. Computers can facilitate user-to-user or computer-to-computer communications, provide data storage solutions, conduct data analysis and/or transformation, and undertake various other tasks. The terms utilized herein may be used interchangeably in certain contexts, as would be appreciated by those skilled in the art. For example, the term device, smartphone, or tablets are all a form of computer, and a computer may also include a virtual machine run on software or a distributed ledger such as the Ethereum Network.

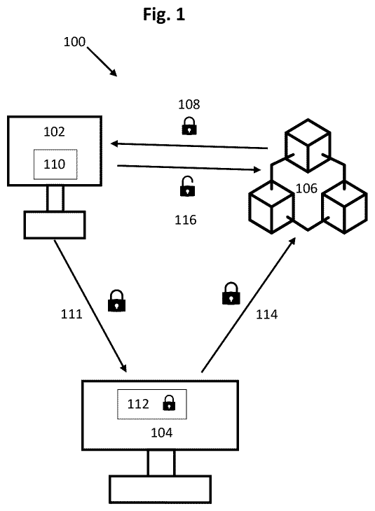

Referring to FIG. 1, there is shown a simplified block diagram of the cryptographically verifiable logger system 100 comprising an agent device 102, a target device 104 and a blockchain 106 according to an embodiment of the invention. The agent 102 can interface with an API of the blockchain 106 to download a unique instance of a logger 110 via an encrypted connection 108. The logger 110 generates a unique public key to encrypt a log and unique private key which is securely transferred to the agent (e.g. utilizing end-to-end encryption) separately from the logger 110. The blockchain API registers timestamp of the unique instance of logger creation on the blockchain. The agent operating the agent device 102 can then install the logger 110 on a target device 104, via an encrypted connection 111. A person skilled in the art will understand that an encrypted connection can refer to end-to-end encryption, but there will be other forms of connection allowing transfer of the logger that can ensure it is not tampered with or intercepted. The installed logger 112 will passively monitor the target device 104 and create a log encrypted with its public key. The installed logger 112 is also configured to upload its encrypted log via an encrypted connection 114 to the blockchain 106. The agent can then verify the authenticity and immutability of the log by decrypting the log via an encrypted connection 116, which is otherwise unable to be tampered with, and represents strong evidence of the authenticity of the log, assuming that the installation onto the target device 104 was not detected or interfered with.

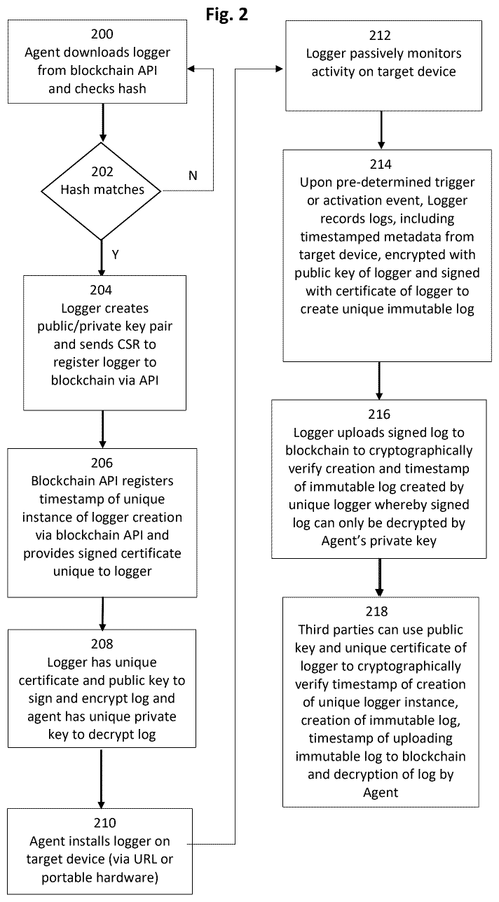

Referring to FIG. 2, there is shown a flow chart of a method for a software logger to record a cryptographically verifiable log on a target device which is immutably recorded on a blockchain according to an embodiment of the invention. At step 200, an agent downloads the logger from a Blockchain API and checks the hash at step 202 which is used to verify if the downloaded version of the logger is the same as the instance of the logger recorded on the blockchain. If the hash does not match, then the agent should go back to step 200 because they may have downloaded a compromised logger, otherwise if the hash matches, at step 204, the logger creates public/private key pair and sends a Certificate Signing Request (CSR) to the Blockchain via API. At step 206, blockchain registers timestamp of the unique instance of logger creation and provides a signed certificate unique to logger. At step 208, the logger has a unique certificate to show it is a unique instance of a logger created by the blockchain API and registered on the blockchain with a timestamp, and unique public key to sign and encrypt log and agent has unique private key to decrypt log. It will be apparent to those skilled in the art that a certificate signing request is not needed to verify the uniqueness of the logger's log and other methods will be possible, including storing the unique hash of that unique instance of the logger at step 202 on the blockchain via API. Accordingly, this step and reference to a certificate in subsequent steps could be removed, according to a simpler embodiment. At step 210, the agent installs the logger on a target device (e.g. via URL or portable hardware such as thumb drive). At step 212, the logger passively monitors activity on target device by avoiding detection, including the use of logger countermeasures discussed below. At step 214, upon a pre-determined trigger or activation event, such as, but not limited to detection of a specific sequence of keystrokes or images on the video or screen, or sounds on the microphone, the logger records logs, including timestamped metadata from the target device, encrypted with public key of logger and signed with the certificate of logger to create a unique immutable log. Such logs could include keystrokes, mouse or trackpad, screen recording, video, and/or microphone. At step 216, the logger uploads signed log to the blockchain to cryptographically verify creation and timestamp of immutable log created by unique logger, whereby signed log can only be decrypted by agent's private key. At step 218, third parties can use public key and unique certificate of logger to cryptographically verify timestamp of creation of unique logger instance, creation of immutable log, timestamp of uploading immutable log to blockchain and decryption of log by agent.

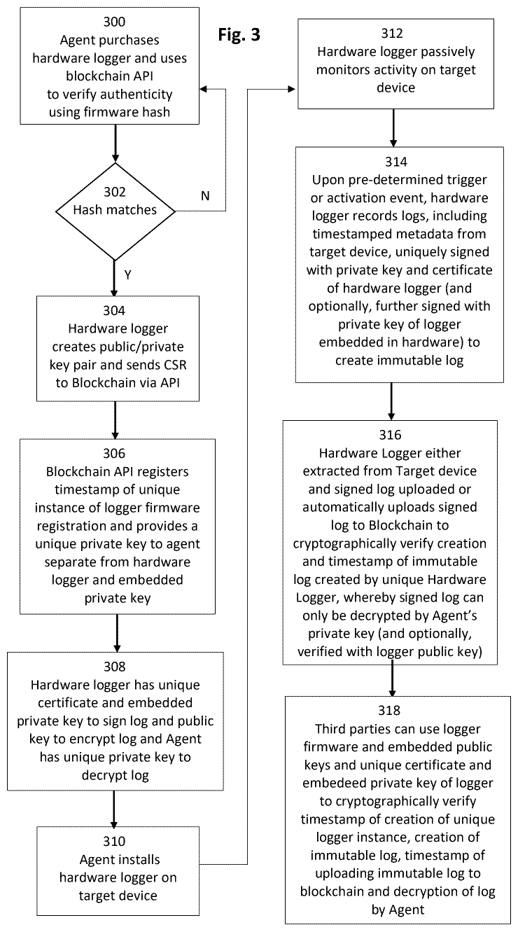

Referring to FIG. 3, there is shown a flow chart of a method for a hardware logger to record a cryptographically verifiable log on a target device which is immutably recorded on a blockchain according to an alternative embodiment of the invention. At step 300, the agent purchases hardware logger and uses blockchain API to verify its authenticity by downloading a unique instance of firmware using a firmware hash which is used to verify if the downloaded version of the firmware is the instance of the hardware logger firmware recorded on the blockchain. At step 302, if the hash does not match, then the agent should go back to step 300 and purchase another hardware logger or download a different firmware version, as applicable, otherwise, at step 304, the hardware logger creates public/private key pair and sends Certificate Signing Request (CSR) to the Blockchain via API. At step 306, the blockchain registers the timestamp of unique instance of hardware logger firmware registration and provides a unique private key to agent separate from hardware logger. The hardware logger also has a unique embedded private key that automatically signs log to verify that the log was generated by that instance of the hardware logger, and can also register the embedded public key pair of embedded private key via blockchain API. It will also be apparent to those skilled in the art that a certificate signing request is not needed to verify the uniqueness of the hardware logger's log and other methods will be possible, including storing the unique hash of that unique instance of the firmware of the hardware logger at step 302 on the blockchain via API. Accordingly, this step and reference to a certificate in subsequent steps could be removed, according to a simpler embodiment. At step 308, hardware logger has unique certificate and embedded private key to sign log and public key to encrypt log and agent has unique private key to decrypt log. At step 310, the agent installs hardware logger on a target device. At step 312, the hardware logger passively monitors activity on a target device by avoiding detection, including the use of logger countermeasures discussed below. At step 314, upon a pre-determined trigger or activation event, such as but not limited to detection of a specific sequence of keystrokes or image on the video or sounds on the microphone, hardware logger records logs, including timestamped metadata from target device, uniquely signed with certificate of hardware logger (and optionally, further signed with private key of logger embedded in hardware) to create immutable log. At 316, hardware logger either extracted from target device and signed log uploaded or automatically uploads signed log to blockchain to cryptographically verify creation and timestamp of immutable log created by unique hardware logger, whereby signed log can only be decrypted by agent's private key (and optionally, also verified with logger embedded public key, which was registered by the blockchain API). At step 318, third parties can use logger firmware and embedded public keys and unique certificate and embedded private key of logger to cryptographically verify timestamp of creation of unique logger instance, creation of immutable log, timestamp of uploading immutable log to blockchain and decryption of log by Agent

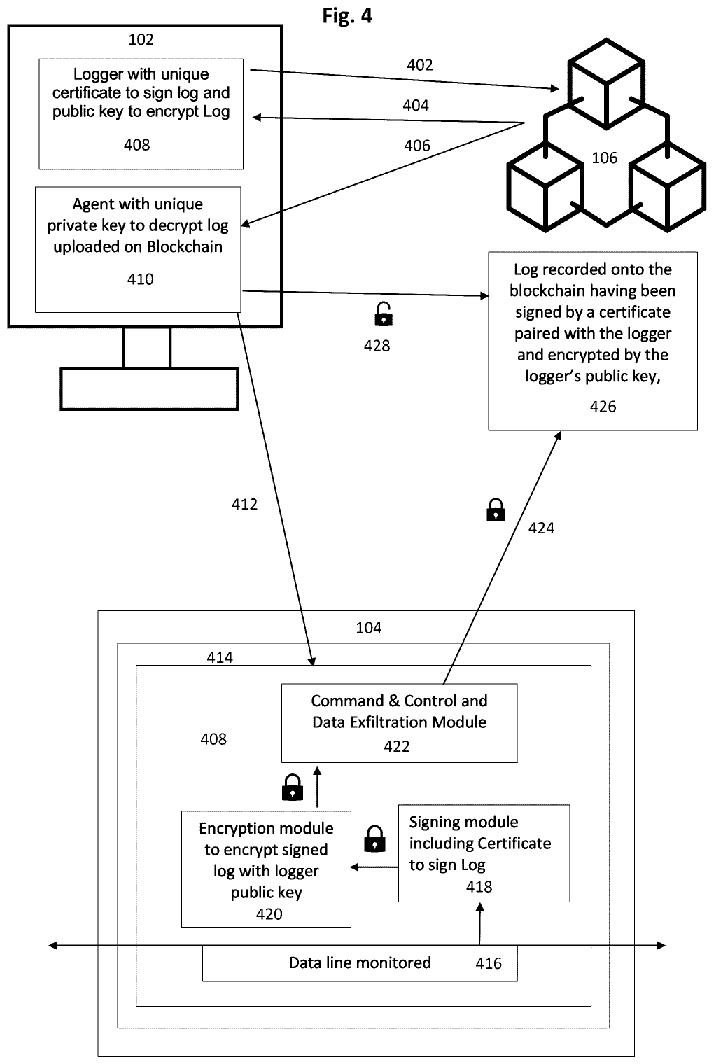

Referring to FIG. 4, there is shown an expanded block diagram of the cryptographically verifiable software logger system comprising an agent device 102, a target device 104 and a blockchain 106 according to an embodiment of the invention. First, the agent will make a request 402 to download a new instance of the logger from the blockchain 106 via its API. At the next step 404, the agent will download a logger 408 with unique certificate to sign log and public key to encrypt the log. At step 406, the agent will also receive a unique private key 410 to decrypt immutable log when it is later uploaded to the blockchain 106. At 412 the agent installs the logger 112 on a target device 104. Preferably, the logger 408 will include a countermeasures “shell” 414 to ensure it can evade detection and disablement by the target device 104 as well as being able to monitor a data line 416, such as keystrokes, screen, video, mouse activity, and/or microphone. A person skilled in the art will recognise that such countermeasures 414 are necessarily an arms race between antivirus programmes and logging programmes, and will evolve over time. For this embodiment of the invention, it will not be necessary to prescribe what these specific countermeasures are, but may include, for example, using software that is whitelisted and controlling the rootkit or OS kernel to hide processes. Upon the detection of a pre-determined event on the passively monitored data line, for example, certain keywords being typed, keyboard, screen or mouse activity, facial recognition on the video, or voice of an individual, the logger will record a log whereby the signing module 418 including certificate will sign the log in order to verify that it was recorded by that logger, and then the encryption module 420 will encrypt the log with the logger's public key. The command and control and data exfiltration module 422 will either be controlled by the agent or automatically upload the encrypted log 424 to the blockchain 106 through a channel that can evade detection (e.g. disguised as a software crash report or security update). At 426, the log is then recorded onto the blockchain 106 having been signed by a certificate paired with the logger and having been encrypted by the logger's public key, ready to be decrypted by the agent's private key for verification that the log is authentic. At 428, the agent decrypts the log, which is only possible for the version of the logger downloaded and installed by the agent. This provides strong evidence that this version of the logger and its log was not altered and is genuine.

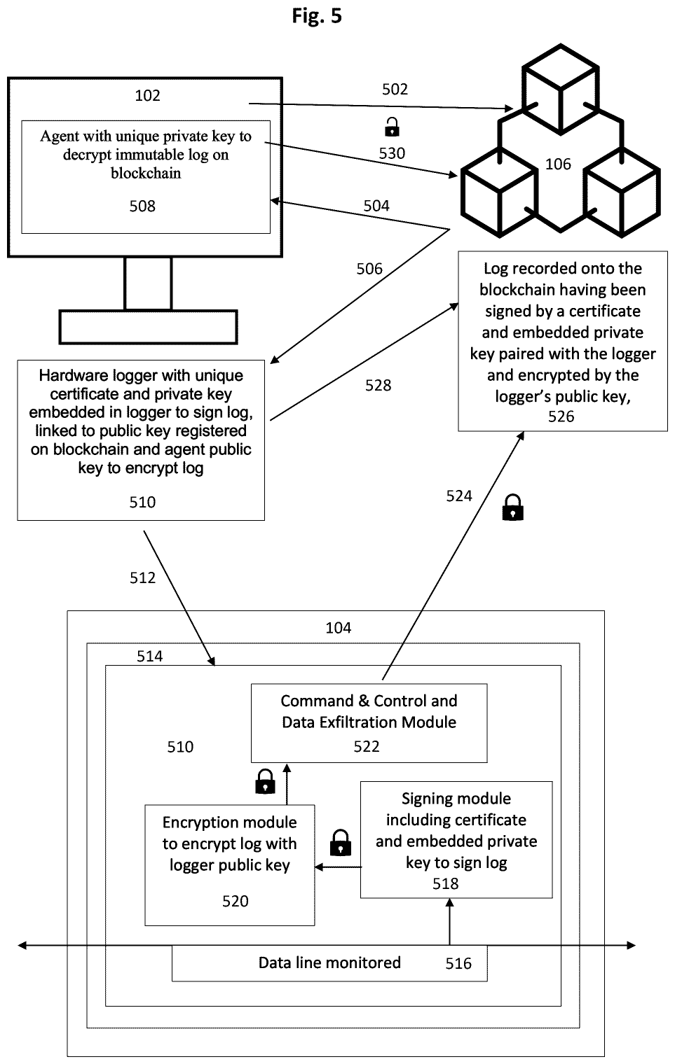

Referring to FIG. 5, there is shown an expanded block diagram of the cryptographically verifiable hardware logger system comprising an agent device 102, a target device 104 and a blockchain 106 according to an embodiment of the invention. First the agent will make a request 502 to register a hardware logger 510 with the blockchain 106 via its API. At the next step 504, the agent will download 508 a unique private key to decrypt the log. At step 506, the hardware logger 510 will create a certificate signing request and shall possess a unique certificate downloaded from the blockchain 106 and private key embedded in hardware logger 510 to sign its log, said embedded private key paired with a public key registered on the blockchain at the time the hardware logger is registered using the blockchain API, and also possesses the agent public key to encrypt the log which is linked to agent's private key, which is held separately by the agent and not on the hardware logger. At 512, the agent installs the hardware logger 510 on a target device 104. Preferably, the hardware logger 510 will include a countermeasures “shell” 514 to ensure it can evade detection and disablement by the target device 104 as well as being able to monitor a data line 516, such as keystrokes, screen, webcam, mouse activity, or sounds. Notably, a hardware device does not run on the target device's operating system, which makes detection more difficult. A person skilled in the art will recognise that such countermeasures 514 are necessarily an arms race between antivirus programmes and hardware loggers and will evolve over time. For this embodiment of the invention, it will not be necessary to prescribe what these are, but may include using software that is whitelisted, controlling the rootkit or OS kernel to hide processes. Upon the detection of a pre-determined event on the passively monitored data line, for example, certain keywords being typed, keyboard or mouse activity, or facial recognition on the video monitor, or a recognisable voice, the hardware logger will record a log whereby the signing module 518 including certificate and embedded private key will sign the log in order to verify that it was recorded by that hardware logger, and then the encryption module 520 will encrypt the log with the signed certificate and agent's public key. The command and control and data exfiltration module 522 will either be controlled by the agent or automatically upload the encrypted log 524 to the blockchain 106 through a channel that can evade detection (e.g. disguised as a software crash report or security update) or when the hardware logger 510 is physically removed from the target device 104. At 526, the log is then recorded onto the blockchain 106 having signed by a unique certificate and embedded private key linked to the hardware logger and having been encrypted by the logger's public key, ready to be decrypted by the agent's private key for verification that the log is authentic. At 528, the log uploaded to the blockchain that was signed by the unique certificate hardware logger private key is verified by with the linked blockchain public key to authenticate that the log was associated with the hardware logger that was originally registered to the blockchain 106 at step 506. At 530, the agent decrypts the log, which is only possible for the version of the hardware logger registered by the agent. This provides strong evidence that this version of the hardware logger's log was not altered and is genuine.

It should be apparent to those skilled in the art that the log uploaded to the blockchain by the logger or hardware logger does not need to be the entire log in order to verify its authenticity but could be a hash of the log. This can prevent the blockchain from being overloaded by processing data. However, ideally the entire log is uploaded as blockchains become more capable of handling more data. While this embodiment refers to a single blockchain, it should also be apparent to those skilled in the art that multiple blockchains can be used to provide redundancy.

While the invention has been illustrated and described in detail in the foregoing description, such illustration and description are to be considered illustrative or exemplary and non-restrictive; the invention is thus not limited to the disclosed embodiments. Features mentioned in connection with one embodiment described herein may also be advantageous as features of another embodiment described herein without explicitly showing these features. Variations to the disclosed embodiments can be understood and effected by those skilled in the art and practicing the claimed invention, from a study of the disclosure and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. A system is described herein for providing a cryptographically secure record on a database shared by all computing nodes participating in a system based on a blockchain protocol comprising:
providing a unique logger associated with a unique cryptographic private and public key pair which is available to be downloaded from a blockchain by an agent that is provided sole access to the private key;
wherein upon installation of said logger on a target device by an agent, the logger is configured to:
create a log encrypted with its unique public key by recording inputs from the target device's environment with timestamps including keystrokes, screenshots, video, or sounds;
store said log in a memory;
upload said log to the blockchain;
wherein said private key can decrypt the log on said blockchain to verify its authenticity and immutability.

2. The system of claim 1 wherein the logger is configured to automatically record and encrypt a log with its unique public key at pre-determined time or event occurring.

3. The system of claim 2 wherein the pre-determined time or event to record the log and upload the log to the blockchain can be configured by the agent.

4. The system and method of claim 3 wherein the pre-determined event to record the log and upload the log to the blockchain includes detection of specific keystrokes, screenshots, or video.

5. The system of claim 1 wherein the agent sends a certificate signing request to blockchain via a blockchain API to register the unique instance of logger creation with timestamp and the blockchain API provides agent signed certificate unique to logger, which is used to sign log prior to encryption of the log by the public key.

6. The system of claim 1 wherein the logger is a hardware logger and includes an unique embedded private key used to automatically sign log prior to encryption of the log by the public key.

7. A computer-based method for generating a cryptographically secure logger is provided comprising the steps of:
accessing, by a processor, a database shared by all computing nodes participating in a system based on a blockchain protocol, the database including transactions and blocks, where the transactions are data to be stored in a blockchain and the blocks are records that confirm when and in what sequence certain transaction became journaled as part of the blockchain;
providing a unique logger included in a data storage parameter of the blockchain which is configured to be associated with a unique cryptographic private and public key pair, that can record a log that can be verified by said blockchain using the private key held by an agent;
downloading the logger to a separate agent device;
installing the logger on a target device by the agent;
wherein said logger is configured to automatically record and encrypt a log with its unique public cryptographic key, by recording inputs from the target device's environment including keystrokes, screenshots, video, or sound at a pre-determined time or event configured by an agent, and store it in non-volatile memory together with time stamps;
uploading said logger's encrypted log to the blockchain at a predetermined time or event configured by said agent;
wherein said agent holding said private cryptographic key can then decrypt said immutable log on the blockchain to verify the authenticity of the log.

8. The method of claim 6 wherein the logger is configured to automatically record and encrypt the log with its unique public key at the pre-determined time or event occurring.

9. The method of claim 7 wherein the pre-determined time or event to record the log and upload the log to the blockchain can be configured by the agent.

10. The method of claim 8 wherein the pre-determined event to record the log and upload the log to the blockchain at a pre-determined time includes detection of specific keystrokes, screenshots, video or sound.

11. The method of claim 6 wherein the agent sends a certificate signing request to blockchain via a blockchain API to register the unique instance of logger creation with timestamp and the blockchain API provides agent signed certificate unique to logger, which is used to sign log prior to encryption of the log by the public key.

12. The method of claim 1 wherein the logger is a hardware logger and includes an unique embedded private key used to automatically sign log prior to encryption of the log by the public key.
